(19) United States
(12) Patent Application Publication
(10) Pub. No.: US 2025/0200402 A1
(43) Pub. Date: Jun. 19, 2025

(54) METHODS AND APPARATUS FOR REMEMBERING AND RECALLING CONTEXT IN COMPLEX AI BASED DECISION FLOWS

(71) Applicant: CharliAI Inc., Vancouver (CA)

(72) Inventors: Kevin COLLINS, Maple Ridge (CA); Elham ALIPOUR KHAYER, North Vancouver (CA); Joel EMERY, Coquitlam (CA); Fabien Warniez, Port Moody (CA)

(73) Assignee: CharliAI Inc., Vancouver (CA)

(21) Appl. No.: 18/983,648

(22) Filed: Dec. 17, 2024

Related U.S. Application Data
(60) Provisional application No. 63/612,060, filed on Dec. 19, 2023.

(51) Int. Cl. G06N 5/045

(52) U.S. Cl. CPC G06N 5/045

(57) ABSTRACT

There is a disclosed computing environment having an AI based decision flow system capable of remembering and recalling context of AI based decision flows. The AI based decision flow system in response to a user making a request through a user interface performs via one or more processors, decision flows by processing a series of decision-making execution steps of code or logic to predict outcomes and make the predicted outcomes available to the user via the user interface. The system captures the context of paused decision flows and determines from the context captured one or more logical points from which an associated paused decision flow may be resumed. The logical points are stored in memory and recalled from memory when inputs are present that permit the associated paused decision flow to continue.

### CROSS REFERENCE TO RELATED APPLICATIONS

This application claims priority to and the benefit of U.S. Provisional Application No. 63/612,060, entitled “METHODS AND APPARATUS FOR REMEMBERING AND RECALLING CONTEXT IN COMPLEX AI BASED DECISION FLOWS” and filed Dec. 19, 2023, which is hereby incorporated by reference in its entirety for all purposes.

### FIELD OF THE DISCLOSURE

The present disclosure relates to a computing environment, including a closed computing system, a cloud-based computing network, or a hybrid of closed and cloud-based computing environments, in which context of artificial intelligence (AI) based decision flows is remembered and recalled, and more particularly, for recalling logical points in decision flows from which paused decision flows may be resumed.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Large-scale computing applications are often deployed across a combination of resources in a distributed computing system. Provisioning resources and orchestrating application workloads across these resources in an efficient manner can be extremely challenging, particularly in view of the growing complexity and continuously evolving nature of these resource deployments, along with the diversity of workloads that are being deployed across them.

Complex AI based decision flows refer to the intricate and sophisticated processes in which artificial intelligence (AI) systems make decisions. These decision flows typically involve multiple interconnected steps, algorithms, and logic rules that enable AI systems to analyze large sets of data, evaluate various factors, and arrive at informed and automated decisions. Within complex AI based decision flows, AI algorithms are designed to manage intricate decision-making scenarios, incorporating machine learning techniques and advanced neural networks. Such decision flows combine diverse data sources, including structured and unstructured data, to provide insightful and valuable outputs. By leveraging AI techniques, these decision flows can analyze large volumes of data, identify patterns, predict outcomes, and deliver more efficient, accurate, and consistent decision-making capabilities.

AI systems performing complex AI based decision flows may need human supervision, intervention, or feedback to function properly, or it may need to coordinate with other AI systems or human agents to achieve a common goal. This raises challenges for scaling of complex AI decision flows in having to deal with the dependencies and delays that may arise from waiting on human input and other AI systems for data input. This affects the speed and quality of achieving the desired outcome from the AI system.

### BRIEF SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

The present disclosure relates to a computing environment in which context of artificial intelligence (AI) based decision flows is remembered and recalled, and more particularly, for recalling logical points in decision flows from which paused decision flows may be resumed.

In one aspect, there is provided a computer implemented method for remembering and recalling context of decision flows in an AI based decision flow system that produces outcomes for users in response to user requests. The method comprises: executing, via one or more processors, one or more series of decision-making execution steps that produce one or more decision flows; pausing the one or more decision flows when input information is missing for the one or more decision flows to execute a next decision-making execution step; capturing as context decision flow information derived from prior decision-making execution steps transactions, interactions, and data values from the start of the one or more decision flows until a specific point in time through the one or more decision flows or until at least one of the decision flows is paused; determining from the context, via the one or more processors, one or more logical points in the one or more paused decision flows from which the one or more paused decision flows is to be subsequently resumed; storing in memory the one or more logical points and the captured context; recalling the one or more logical points and the context from memory when the missing input information becomes present for the one or more decision flows; and, resuming execution, via one or more processors, of the next decision-making execution step of the paused one or more decision flows from the one or more logical points with the context to improve efficiency and speed of the one or more decision flows to produce the outcomes for the users.

In another aspect, there is provided a computing system for remembering and recalling context in paused decision flows to improve efficiency and speed in resuming the paused decision flows in an AI based decision flow system that, in response to a user making a request through a user interface, performs decision flows by processing a series of decision-making execution steps of code or logic to predict outcomes and make the predicted outcomes available to the user via the user interface. The system comprises one or more processors; and a memory comprising instructions that when executed, cause the computing system to: capture the context of one or more decision flows; determine from the context captured one or more logical points at which one or more of the paused decision flows have occurred and from where the one or more of the paused decision flows may be resumed; store in the memory the one or more logical points and the captured context; recall the one or more logical points from the memory when inputs are present that permit the paused decision flow to continue; and resume the one or more of the paused decision flows from the one or more logical points utilizing the inputs to continue the series of decision-making execution steps to arrive at the predicted outcomes and make the predicted outcomes available to the user through the user interface.

In another embodiment, the decision flow process resolves missing or conflicted data points as part of continuing its decision flow steps. The resolution process involves determination using rules-based logic or machine learning to determine best how to resolve the missing or conflicted data. The resolution is stored along with contextual data that was used to resolve the missing or conflicted data. The contextual data is the relevant metadata associated with collection of missing data and/or determination of the best data point from a conflicted set of data points. The metadata is the contextual relevance for memorization and recall. The decision flow continues processing after resolving the missing or conflicted data points. Upon subsequent execution of similar decision flows, the decision flow process can automatically resolve missing or conflicted information by recalling solutions using the contextual metadata.

In another aspect, the decision flow process can be iterative such that the iterations can generate the same or different results. The iterative decision flow process provides dynamic learning as the AI adjusts based on prior memory recall and can continuously learn and adapt through the iterations.

In yet another aspect, there is provided a non-transitory computer-readable storage medium wherein the computer-readable storage medium includes instructions that when executed by a computer, cause the computer to: determine the one or more logical points by abstraction of the captured context decision flow logical layers, and grouping and marking the logical layers with decision flow markers at the one or more logical points; recall the one or more logical points from the decision flow markers in the decision flow logical layers; and wherein the one or more logical points comprise multiple non-fixed logical points and the logical layers are marked at the multiple non-fixed logical points within each of the decision flows that are suitable for resuming performance of series of decision-making execution steps from one of the multiple non-fixed logical resume points.

### BRIEF DESCRIPTION OF THE VIEWS OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. To easily identify the discussion of any particular element or act, the most significant digit or digits in a reference number refer to the figure number in which that element is first introduced.

FIG. 1 illustrates an embodiment of a computing environment in which an AI based decision flow system remembers and recalls decision flow context, in accordance with various aspects discussed herein.

FIG. 2 illustrates an embodiment of an AI based decision flow system having a decision flow capture and recall system associated therewith, in accordance with various aspects discussed herein.

FIG. 3 illustrates a simplified decision flow illustrating the capture, remembering and recalling logical points in accordance with various aspects of an AI based decision flow system as discussed herein.

FIG. 4 illustrates a routine for remembering and recalling context of decision flows in an AI based decision flow system that produces outcomes for users in response to user requests in accordance with one embodiment.

FIG. 5 illustrates a routine for remembering and recalling context of decision flows in an AI based decision flow system that produces outcomes for users in response to user requests in accordance with one embodiment.

FIG. 6 illustrates a routine for remembering and recalling context of decision flows in an AI based decision flow system that produces outcomes for users in response to user requests in accordance with one embodiment.

FIG. 7 illustrates architecture for remembering and recalling context of decision flows in an AI based decision flow system in accordance with one embodiment.

### DETAILED DESCRIPTION

The aspects described herein relate to, inter alia, a computing environment having an AI based decision flow system that predicts outcomes for use by users in response to requests made by users and, more particularly, to remembering and recalling context of AI based decision flows that have been executed previously, are currently executing or are paused. The AI based decision flow system, by remembering and recalling context, provides improved accuracy and speed of the system to reach final decisions (outcomes) and/or recommendations, whereby the predicted outcomes are provided to a user via a user interface.

In the present disclosure, “context” refers to a collection of information that may include conditions, data points (e.g., entities), metadata, and circumstances and that is derived from prior decision flow steps, transactions, interactions, and data values that have been captured from the start of a decision flow until a specific point in time through the decision flow or until the decision flow is paused. This may include various elements such as, for example, prior decision-making execution steps, transactions, interactions involving single or multiple parties, and data utilized as input to generate corresponding outputs during previous decision flows. Further, a specific point in time through the decision flow refers to the capture or recording of context from the beginning of the decision flow until this specific moment, which could be any point during the decision flow or when the decision flow is paused.

AI based decision flows may be paused for a variety of reasons. One reason may be the need for human intervention. In one aspect, for example, in a “Human in the Loop” (HITL) management model, a human may be assisted by a machine and the human may be doing the decision making while the machine may be providing decision support or partial automation of some decisions, or parts of decisions. In this case, the decision flow process may be paused to allow for human intervention or other external processes such as, for example, an external computer routine or machine process.

Pausing decision flows often occurs to allow for certain interactions by external processes, external systems, and humans. Decision flows operate across lengthy processes and can take from many minutes to many hours, days or even weeks to complete. In one example, a decision flow might involve external systems to complete processing and updates to their embedded databases and may also involve one or more humans to execute an approval process thereby taking lengthy times to complete. The memorization and recall are critically important for maintaining the viability and integrity of the decision flows.

Overall, while pausing AI based decision flows commonly occurs, it may create disadvantages and the present disclosure discusses methods and systems that may be implemented by a computing environment for carefully managing such pauses through remembering and recalling of context of decision flows or decision workflows.

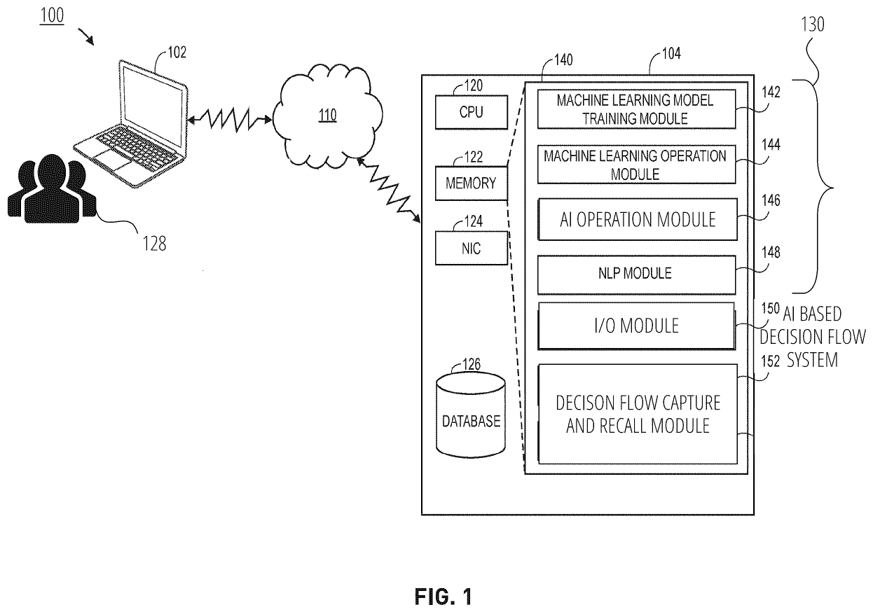

FIG. 1 depicts a computing environment 100 in which AI based decision flows, in response to a user making a request through a user interface, are performed. The decision flows are performed in an AI based decision flow system 130, via one or more processors, by processing a series of decision-making execution steps of code or logic to predict outcomes and make the predicted outcomes available to the user via the user interface. In an aspect of the present disclosure, the AI based decision flows are remembered and recalled for improving accuracy, speed and efficiency of the AI based decision flow system's performance through the reuse of previous knowledge thereby avoiding redundant computations.

In the example aspect of FIG. 1, computing environment 100 includes a user interface 102, which may comprise one or more computers that can be accessed by one or more users to make various requests. One or more users 128 may interact with the AI based decision-making system through the user interface 102 to make various requests. These requests may include, but are not limited to:
1. Input of data: Users 128 may input relevant data, such as, for example, numerical values, text descriptions, or multimedia files, for the AI system 140 to analyze and process.
2. Decision inquiries: Users 128 may seek decisions or recommendations from the AI system 140 based on specific criteria or conditions provided. For example, a user may request the system to recommend suitable products based on their specific preferences and needs.
3. Predictive analysis: Users 128 may request the AI system 140 to provide predictive insights or forecasts based on historical data and patterns. This may aid in making informed decisions or planning future strategies.
4. Optimization queries: Users 128 may ask the AI system 140 to optimize certain parameters or achieve specific goals. This may involve finding the best solution among various possibilities or maximizing efficiency in resource allocation.
5. Comparative analysis: Users 128 may request the AI system 140 to compare different options or scenarios and provide insights or recommendations based on predefined criteria. This may assist in evaluating different strategies or alternatives.
6. Feedback and adaptability: Users 128 may provide feedback to the AI system 140 regarding the accuracy or relevance of its decisions, allowing the AI system 140 to improve its predictive capabilities over time.

It should be understood that the above examples are non-limiting, and users 128 may make a wide range of requests to the AI system 140 via the user interface 102, depending on the specific implementation and the capabilities of the system.

In various aspects, user interface(s) 102 comprise multiple computers, which may comprise multiple, redundant, or replicated client computers accessed by one or more users 128. The user interface 102 may include a memory and a processor for, respectively, storing and executing one or more modules. The memory may include one or more suitable storage media such as, for example, a magnetic storage device, a solid-state drive, random access memory (RAM), etc. A proprietor of the present techniques may access the computing environment 100 via the user interface 102, to access services or other components of the computing environment 100 via the electronic network 110. A customer, or user, of the computing environment 100 (e.g., a persona, as discussed herein) may access the computing environment 100 via user interface 102. The user interface 102 may be any suitable device (e.g., a laptop, a smart phone, a tablet, a wearable device, a blade server, etc.). Users may utilize smartphones or tablets as the user interface to interact with the AI system 140. These devices offer touchscreens, voice input capabilities, and other sensors that enable seamless interaction. The user may use smart speakers or virtual assistants with which the AI system 140 may be integrated with smart speakers like Amazon Echo or virtual assistants like Google Assistant. This allows users to make voice-based requests and receive audio responses without needing a traditional graphical user interface. The user interface may comprise wearable devices such as, for example, smartwatches or fitness trackers that may serve as an interface for the AI system 140. Users may input requests or receive notifications through these wearable devices, offering convenience and mobility. The user interface may include virtual reality (VR) or augmented reality (AR) headsets which may provide immersive experiences and may be used to interact with the AI system 140 in virtual or augmented platforms. This may permit users to visualize data or make gestures to interact with the AI system 140. The user interface may be responsive to gesture recognition and may include cameras or sensors that can track users' hand movements or gestures that may be used for interacting with the AI system 140. This may permit users to perform specific gestures to input commands or navigate through the system's interface. The user interface may provide for voice and speech recognition and may include dedicated voice recognition devices, such as, for example, microphones or headsets that may capture users' speech and convert it into text or commands for the AI system 140. This enables hands-free interaction and accessibility between the user and the AI system 140. The user interface may include biometric devices integrated with the AI system 140, such as, for example, fingerprint scanners or facial recognition cameras that may provide secure authentication and personalized experiences. These are just a few examples of input/output devices that can be used to interface with an AI based decision system, depending on the specific requirements and applications. The choice of device will depend on factors such as, for example, user preferences, convenience, and the nature of the interactions needed with the system.

The computing environment 100 of FIG. 1 further includes one or more servers 104 that in turn may include one or more servers. In further aspects, the servers 104 may be implemented as cloud-based servers of the computing environment 100, including, and not limited to, a cloud-based computing platform where AI and ML (machine learning) models of the environment are distributed in the cloud. For example, servers 104 may be any one or more cloud-based environment(s) such as, for example, Microsoft Azure, AWS, Terraform, etc. The computing environment 100 may further include a current computing environment, representing a current computing environment (e.g., on premises) of a customer and/or future computing environment, representing a future computing environment (e.g., a cloud computing environment, multi-cloud environment, etc.) of a customer or organization. The computing environment 100 may further include an electronic network 110 communicatively coupling other aspects of the computing environment 100. For example, the servers 104 may access one or more other computing environments.

In some aspects, servers 104 may perform the functionalities as discussed herein as part of a cloud-computing environment or may otherwise communicate with other hardware or software components within one or more cloud computing environments to send, retrieve, or otherwise analyze data or information described herein. For example, in aspects of the present techniques, the computing environment may comprise a customer on-premise computing environment, a multi-cloud computing environment, a public cloud-computing environment, a private cloud computing environment, and/or a hybrid cloud-computing environment. For example, the customer may host one or more services in a public cloud-computing environment (e.g., Alibaba Cloud, Amazon Web Services (AWS), Google Cloud, IBM Cloud, Microsoft Azure, etc.). The public cloud-computing environment may be a traditional off-premise cloud (i.e., not physically hosted at a location owned/controlled by the customer). Alternatively, or in addition, aspects of the public cloud may be hosted on-premise at a location owned/controlled by the customer. The public cloud may be partitioned using virtualization and multi-tenancy techniques and may include one or more of the customers' IaaS and/or PaaS services.

In some aspects of the present techniques, the computing environment of the customer may comprise a private cloud that includes one or more cloud computing resources (e.g., one or more servers, one or more databases, one or more virtual machines, etc.) dedicated to the customer's exclusive use. In some aspects, the private cloud may be distinguished by its isolation to hardware exclusive to the customer's use. The private clouds may be located on-premise of the customer or constructed from off-premise cloud computing resources (e.g., cloud computing resources located in a remote data center). The private clouds may be third-party managed and/or dedicated clouds.

In still further aspects of the present techniques, the environment may comprise a hybrid cloud that includes multiple cloud computing environments communicatively coupled via one or more networks (e.g., the electronic network 110). For example, in a hybrid cloud computing aspect, the computing environment may include one or more private clouds, one or more public clouds, a bare-metal (e.g., non-cloud based) system, etc.

The electronic network 110 may comprise any suitable network or networks, including a local area network (LAN), wide area network (WAN), Internet, or combination thereof. For example, the electronic network 110 may include a wireless cellular service (e.g., 4G). Generally, the network 110 enables bidirectional communication between the user interface 102 and the servers 104; a first user interface 102 and a second user interface 102; etc. As shown in FIG. 1, servers 104 are communicatively connected, via computer electronic network 110 to the one or more client user interfaces or computing devices 102. In some aspects, network 110 may comprise a cellular base station, such as, for example, cell tower(s), communicating to the one or more components of the computing environment 100 via wired/wireless communications based on any one or more of various mobile phone standards, including NMT, GSM, CDMA, UMMTS, LTE, 5G, or the like. Additionally, or alternatively, network 110 may comprise one or more routers, wireless switches, or other such wireless connection points communicating to the components of the computing environment 100 via wireless communications based on any one or more of various wireless standards, including by non-limiting example, IEEE 802.11a/b/c/g (WIFI), the Bluetooth standard, or the like.

The one or more servers 104 may include one or more processors 120, one or more computer memories 122, one or more network interface controllers (NICs) 124 and an electronic database 126. The NIC 124 may include any suitable network interface controller(s) and may communicate over the network 110 via any suitable wired and/or wireless connection. The servers 104 may include one or more input devices (not depicted) and may include one or more devices for allowing a user to enter inputs (e.g., data) into the servers 104. For example, the input device may include a keyboard, a mouse, a microphone, a camera, etc. In some aspects, the input device may be a dedicated client computing device 102 (e.g., located local to or remote to the servers 104). The NIC 124 may include one or more transceivers (e.g., WWAN, WLAN, and/or WPAN transceivers) functioning in accordance with IEEE standards, 3GPP standards, or other standards, and that may be used in receipt and transmission of data via external/network ports connected to the computer electronic network 110.

The database 126 may be a relational database, such as, for example, Oracle, DB2, MySQL, a NoSQL based database, such as, for example, MongoDB, or another suitable database. The database 126 may store data used during training and/or operation of one or more ML/AI models. The database 126 may store runtime data (e.g., a customer response received via the network 110, knowledge management information, etc.).

The servers 104 may implement client-server environment technology that may interact, via a computer bus of the servers 104 (not depicted), with the memory(s) 122 (including the applications(s), component(s), API(s), data, etc. stored therein) and/or database 126 to implement or perform the machine readable instructions, methods, processes, elements or limitations, as illustrated, depicted, or described for the various flowcharts, illustrations, diagrams, figures, and/or other disclosure herein.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122 and/or the database 126.

The memory 122 may include one or more forms of volatile and/or non-volatile and, fixed and/or removable memory, such as, for example, read-only memory (ROM), electronic programmable read-only memory (EPROM), random access memory (RAM), erasable electronic programmable read-only memory (EEPROM), and/or other hard drives, flash memory, microSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules that co-operate to form all or a distributed portion of an AI system 140 in the computing environment 100, implemented as respective sets of computer-executable instructions (e.g., one or more source code libraries, trained machine learning models such as, for example, neural networks, convolutional neural networks, reinforcement learning instructions, etc.) as described herein.

In general, a computer program or computer based product, application, or code (e.g., the model(s), such as, for example, machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

For example, in some aspects, the computing modules of the AI system 140 may include a ML model training module 142, comprising a set of computer-executable instructions implementing machine learning training, configuration, parameterization and/or storage functionality. The ML model training module 142 may initialize, train and/or store one or more ML models, as discussed herein. The trained ML models and/or respective sets of ML model parameters may be stored in the database 126, which is accessible or otherwise communicatively coupled to the servers 104. The modules of the AI system 140 may store machine readable instructions, including one or more application(s), one or more software component(s), and/or one or more application programming interfaces (APIs), which may be implemented to facilitate or perform the features, functions, or other disclosure described herein, such as, for example, any methods, processes, elements or limitations, as illustrated, depicted, or described for the various flowcharts, illustrations, diagrams, figures, and/or other disclosure herein. The ML training module 142 may train one or more ML models (e.g., an artificial neural network (ANN)). One or more training data sets may be used for model training in the present techniques, as discussed herein. The input data may have a particular shape that may affect the ANN network architecture. The elements of the training data set may comprise tensors scaled to small values (e.g., in the range of (−1.0, 1.0)). In some aspects, a preprocessing layer may be included during both training and inference phases. This layer might apply advanced techniques such as principal component analysis (PCA), t-distributed stochastic neighbor embedding (t-SNE), or autoencoders for dimension reduction. By leveraging these methods, the dimensionality of the data can be significantly reduced, streamlining the dataset from a high-dimensional space to a more manageable size. This reduction in dimensionality can lead to a marked decrease in the computational resources utilized, including memory usage and CPU cycles, for both training and analysis of the input data.

In general, training an ANN may include establishing a network architecture, or topology, adding layers including activation functions for each layer (e.g., a “leaky” rectified linear unit (ReLU), softmax, hyperbolic tangent, etc.), loss function, and optimizer. In an aspect, the ANN may use different activation functions at each layer, or as between hidden layers and the output layer. It might also utilize a transformer architecture which is efficient in handling sequential data without recurrent connections. A suitable optimizer may include Adam, Nadam, and Ranger optimizers. In an aspect, a different neural network type may be chosen (e.g., a recurrent neural network). Training data may be divided into training, validation, and testing data. For example, 20% of the training data set may be held back for later validation and/or testing. In that example, 80% of the training data set may be used for training. In that example, the training data set may be shuffled before being so divided. Data input to the artificial neural network may be encoded in an N-dimensional tensor, array, matrix, and/or other suitable data structure. In some aspects, training may be performed by successive evaluation (e.g., looping) of the network, using training labeled training samples. The process of training the ANN may cause weights, or parameters, of the ANN to be created. The weights may be initialized to random values. The weights may be adjusted as the network is successively trained, by using one or more gradient descent algorithms, to reduce loss and to cause the values output by the network to converge to expected, or “learned,” values. In an aspect, a regression may be used which has no activation function. Therein, input data may be normalized through techniques such as batch normalization or layer normalization, and a range of loss functions can be employed, including mean squared error, mean absolute error, and custom loss functions tailored to specific objectives, thereby quantifying the model's accuracy and performance in a more nuanced manner.

For example, the ML training module 142 may receive labeled data at an input layer of a model having a networked layer architecture (e.g., a transformer model, a convolutional neural network, a learning ensemble, etc.) for training the one or more ML models to generate ML models. The received data may be processed through multiple interconnected layers, including attention mechanisms in transformer architectures, to establish and refine the weights of nodes, or neurons, across the respective layers. Initially, the weights may be initialized to random values, or they may be initialized using advanced techniques such as Xavier or He initialization. One or more suitable activation functions may be chosen for the training process, including Swish, GELU, or PRELU, as will be appreciated by those of ordinary skill in the art. The method may include training a respective output layer of the one or more machine learning models. The output layer may be trained to output a prediction, for example. In some aspects, the output layer may leverage multi-task learning, allowing the model to simultaneously solve related problems and improve overall performance. Moreover, the output may also include machine learning solutions related to ensemble methods, such as stacking or boosting, to combine predictions from multiple models for enhanced accuracy.

The data used to train the ANN may include heterogeneous data (e.g., textual data, image data, audio data, etc.). In some aspects, multiple ANNs may be separately trained and/or operated. In some aspects, the present techniques may include using a machine learning framework (e.g., Keras, PyTorch, Hugging Face Transformers, scikit-learn, etc.) to facilitate the training and/or operation of machine learning models.

In various aspects, a ML model, as described herein, may be trained using a supervised or unsupervised machine learning program or algorithm. The machine learning program or algorithm may utilize various neural network architectures, including convolutional neural networks, recurrent neural networks, transformers, or hybrid models that learn from multiple feature sets (e.g., structured and unstructured data) in specific domains of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be based on, or otherwise incorporate aspects of one or more machine learning algorithms included as a library or package executed on server(s) 104. For example, libraries may include the TensorFlow based, the Pytorch, Hugging Face Transformers and/or the scikit-learn Python library.

Machine learning may involve identifying and recognizing patterns in existing data (such as, for example, data risk issues, data quality issues, sensitive data, etc.) in order to facilitate making predictions, classifications, and/or identifications for subsequent data (such as, for example, using the models to determine or generate a classification or prediction for, or associated with, applying a data governance engine to train a descriptive analytics model).

Machine learning model(s) may be created and trained based upon example data (e.g., “training data”) inputs or data (which may be termed “features” and “labels”) in order to make valid and reliable predictions for new inputs, such as, for example, testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or other processor(s) may be utilized to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. In the present techniques, unsupervised learning may be used, inter alia, for natural language processing purposes (e.g., for performing topic modeling of words for mapping of personas, industries, etc.) and to identify scored features that can be grouped to make unsupervised decisions (e.g., numerical k-means). Moreover, self-supervised learning methods may also be used to leverage vast amounts of unlabeled data to pre-train models, which can then be fine-tuned for specific tasks, significantly improving performance and reducing reliance on labeled datasets.

Supervised learning, unsupervised machine learning and/or self-supervised learning may also comprise retraining, relearning, or otherwise updating models with new, or different, information, which may include information received, ingested, generated, or otherwise used over time. The disclosures herein may use one or both of such supervised or unsupervised machine learning techniques. In various aspects, training the ML models herein may include generating an ensemble model comprising multiple models or sub-models, comprising models trained by the same and/or different AI algorithms, as described herein, and that are configured to operate together.

In some aspects, the computing modules of the AI system 140 may include a machine learning operation module 144, comprising a set of computer-executable instructions implementing machine learning loading, configuration, initialization, and/or operation functionality. The ML operation module 144 may include instructions for storing trained models (e.g., in the electronic database or memory 126, as a pickled binary, etc.). Once trained, a trained ML model may be operated in inference mode, whereupon when provided with de novo input that the model has not previously been provided, the model may output one or more predictions, classifications, etc. as described herein. In an unsupervised learning aspect, a loss minimization function may be used, for example, to teach a ML model to generate output that resembles known output.

The architecture of the ML model training module 142 and the ML operation module 144 are shown as separate modules and may alternatively be combined or added to each individual module or set of instructions independent from other algorithms/modules.

In some aspects the computing modules of the AI system 140 may include AI operation module 146 which may function as, or as part of, the AI based decision flow system 130. The AI based decision flow system 130 may be utilized by enterprise-level organizations or businesses that use the system to support their operations and decision-making processes. The AI operation module 146 may enable enterprise teams to perform operations with accuracy making use of composite AI for the enterprise. The AI operation module 146 may use secure-by-design infrastructure that is purpose-built to protect customer data and intellectual property, prevent data loss, ensure privacy, and provide a high-reliability and scalable environment while retaining compliance with worldwide regulations. The AI operation module 146 may leverage multiple sources of structured, semi-structured and unstructured data to enhance the enterprise's ability to process and analyze data, make informed decisions, and improve its overall efficiency and effectiveness in achieving digital transformation and to generate fact-based content, such as, for example, reports, recommendations, and insights for review and consideration by enterprise team members. This may allow the enterprise system to be deployed across the enterprise-level organization and used by cross-functional teams to support a wide range of business activities and processes.

In some aspects, the AI operation module 146 may be configured by a variety of components and systems designed to facilitate the processing and analysis of data. These configurations may include, but are not limited to, cloud-based networks, distributed computing systems, and high-performance computing clusters. One of ordinary skill in the art will appreciate that the specific configuration of the AI operation module 146 will depend on the requirements of the enterprise environment and the nature of the data being processed. For example, an enterprise environment that processes large volumes of real-time data may include a distributed computing system with low-latency connections to ensure timely processing and analysis. Similarly, an enterprise environment that performs complex machine learning tasks may include a high-performance computing cluster with specialized hardware to support the computational demands of these tasks.

In some aspects, the computing modules of the AI system 140 may include a natural language processing (NLP) module 148, comprising a set of computer-executable instructions implementing natural language processing functionality. Enterprise team members may interface with the NLP to provide human-to-AI collaboration that is easy to use and works directly with business and technical teams in the organization. The AI operation module 146 together with the NLP module 148 may also allow for headless integration so that teams can work directly with the AI using existing tools such as, for example, email, chat, and other enterprise apps that teams are familiar with. While the modules 146 and 148 are depicted as separate modules, one of ordinary skill in the art will appreciate these modules may be implemented as one module.

In an embodiment, the ML model training module 142, the ML operation module 144, the AI operation module 146, and the NLP module 148 co-operate with each other, and potentially other types of computational models, to form the AI based decision flow system 130 of the present disclosure, as represented by a bracket in FIG. 1. Additionally, an AI based decision flow system 130 may offer features such as, for example, advanced data processing and analysis capabilities, automation features, and adaptive AI technologies, and combine features of intelligent data processing, ETL, automation, adaptive AI, composite AI, and generative AI in one environment. The AI based decision flow system 130 may consume vast amounts of structured, semi-structured, and unstructured data to empower better business decisions. The AI system 140 employing the AI based decision flow system 130 may find enterprise applications across many different and diverse industries, including but not limited to Financial Services, Banking, Commercial Real Estate, Legal and Equity Compensation, Customer Service and Healthcare.

In some aspects, the computing modules of the AI system 140 may include an input/output (I/O) module 150, comprising a set of computer-executable instructions implementing communication functions. The I/O module 150 may include a communication component configured to communicate (e.g., send and receive) data via one or more external/network port(s) to one or more networks or local terminals and/or the user interface 102 for rendering reports, recommendations, and/or insights. In some aspects, servers 104 may include a client-server platform technology such as, for example, ASP.NET, Java J2EE, Ruby on Rails, Node.js, a web service or online API, responsive to receiving and responding to electronic requests.

The I/O module 150 may further include or implement an operator interface configured to present information to an administrator or operator and/or receive inputs from the administrator and/or operator (e.g., via the client computing user interface 102). An operator interface may provide a display screen. I/O module 150 may facilitate I/O components (e.g., ports, capacitive or resistive touch sensitive input panels, keys, buttons, lights, LEDs), which may be directly accessible via, or attached to, servers 104 or may be indirectly accessible via or attached to the user interface 102. According to some aspects, an administrator or operator may access the servers 104 via the user interface 102 to review information, make changes, input training data, initiate training via the ML training module 142, and/or perform other functions (e.g., operation of one or more trained models via the ML operation module 144). In some aspects, the I/O module 150 may include one or more sets of instructions for receiving inputs via a virtual reality interface, a mixed reality interface and/or an augmented reality interface (e.g., via a tablet hardware device, such as, for example, the client computing device 102). The I/O module 150 further permits for enterprise team members or users 128 to intuitively interface with the NLP module 148 and the AI operation module 146 via the user interface 102 thereby building trust and allowing individuals and teams to interact directly with the AI, learning to understand its decisions and how to quickly train it for higher accuracy and more business relevance.

In some aspects, the computing modules of the AI system 140 may include a decision flow capture and recall module 152. While the decision flow capture and recall module 152 and AI operation module 146 are shown as separate modules, one of ordinary skill in the art will appreciate that these modules may be integrated. The decision flow capture and recall module 152 may include computer-executable instructions for capturing information related to real-time decision flows in the server 104 and storing this captured information in memory 122. In the event a decision flow is paused in the AI operation module 146, then the decision flow capture and recall module 152 may capture the decision flow history from the start of the decision process until the pause in the decision process. The decision flow capture and recall module 152 may then determine a logical point in the decision flow history to resume from, once the requisite information is available, for the decision flow process to continue. This logical point may be the last point recorded/captured in the decision flow or may be a logical point prior in the decision flow process to the last point captured. A logical point may provide a more optimal resume point for the process as compared to the last point captured in the history of the decision process. The decision flow capture and recall module 152 is then ready to restart or resume the decision flow by recalling from memory 122 a logical restart point or points associated with the information relating to the decision flow history as captured and stored in memory 122. One of ordinary skill in the art will appreciate that while the decision flow capture and recall module 152 is shown as a single module, it may comprise multiple modules and it may be integrated and form part of the AI operation module.

In an AI system 140 of computing environment 100 having an AI based decision flow system 130, the predictive outputs of the AI system 140 may play a role in helping users 128 make informed decisions and optimize their workflows. These predicted outputs leverage the power of AI and machine learning algorithms to anticipate outcomes or provide insights. These predicted outcomes may be provided through user interface 102 and may include a prediction of time estimation for completing tasks or the overall duration of a workflow. This allows users to allocate resources, set realistic deadlines, and manage expectations. The predicted outcomes via the user interface 102 may include resource allocations where the AI system 140 may predict the optimal allocation of resources, such as, for example, assigning specific team members to tasks based on their expertise or availability by considering factors like workload, skill levels, and historical data to make informed recommendations. The predicted outcomes via the user interface 102 may include risk assessments where the AI system 140 may assess and predict potential risks within the workflow, enabling users to identify areas that might impact project success or compliance. This assists users in implementing risk mitigation strategies proactively. The predicted outcomes via the user interface 102 may include workflow optimizations where the AI system's 140 algorithms may predict potential opportunities for optimizing the workflow, such as, for example, suggesting process improvements or automation possibilities. These insights help users streamline their workflows for enhanced efficiency. The predicted outcomes via the user interface 102 may include performance metrics where the AI may generate predicted performance metrics, such as, for example, productivity indicators, cost-effectiveness estimates, or quality assessments. These predictions assist users in monitoring and managing the overall performance of their workflows. The AI system 140 may predict workload imbalances across team members, suggesting redistributions, task reallocations, or resource adjustments to ensure equitable distribution of work and prevent burnout. The AI system 140 may predict forecasting demand or trends. With access to historical data and external factors, the system can predict future trends, customer demand, or market conditions. This helps users make data-driven decisions and plan their workflows accordingly. The AI system 140 may predict decision support scenarios where the intelligent workflow system can simulate different scenarios and predict the potential outcomes of different decision paths. Users may explore and compare these predicted scenarios to make informed choices in their workflow management. The AI system 140 may predict and alert users to potential anomalies or deviations from expected patterns within the workflow. This enables users to take timely corrective action and maintain workflow integrity. The AI system 140 may predict and make personalized recommendations based on individual user behavior, preferences, and historical data, for improving productivity or addressing specific workflow challenges. These are examples of predicted outputs that an AI based intelligent workflow system such as, for example, AI system 140 can provide through a user interface. The specific types of predictions will vary based on the nature of the workflow, the available data, and the algorithms implemented in the system. The goal is to provide users with valuable insights and enable data-driven decision-making for optimizing their workflows.

The predicted outputs or outcomes in decision flows or decision workflows in the AI system 140 can be delivered to users 128 through the user interface 102 in many ways. For example, the system can generate notifications or alerts to inform users about predicted outputs. These may be displayed as pop-ups, messages, or badges within the user interface. Users can click on the notification to view more details or take appropriate actions. In another example, the user interface may include interactive dashboards where predicted outputs are visualized in the form of charts, graphs, or tables. Users can navigate through different sections of the dashboard to access and analyze the predicted outputs relevant to their workflow. In another example, the system may generate summarized reports or insights that provide a comprehensive overview of the predicted outputs. These reports can be presented within the user interface, allowing users to review and analyze the information at their convenience. In another example, through a dedicated section or panel of the user interface, the system can present recommendations or suggestions based on predicted outputs. These panels can provide actionable insights or prompt users to consider specific improvements in their workflow. In yet another example, the predicted outcomes may be made available to a user via the user interface 102 which may visualize predicted outputs through interactive data visualizations, such as, for example, charts, graphs, or heatmaps. Users can interact with these visualizations to explore and interpret the predicted outputs in a more intuitive and contextual manner. The user interfaces 102 may provide predicted outputs directly within the user interface by utilizing pop-up messages or tooltips. These serve as contextual hints or suggestions related to specific elements or actions in the interface. Workflow insights/widgets may be included in the user interface that display predicted outputs specific to the workflow. For instance, a widget can show predicted time estimations, resource allocations, or risk assessments, providing users with immediate visibility into key predicted outcomes. The predicted outcomes may include personalized notifications delivered to individual users through personalized notifications on the user interface 102. These notifications can be tailored to their roles, preferences, or areas of responsibility within the workflow. The method of delivering predicted outputs to users depends on the design and functionality of the user interface. The goal is to present the information in a clear, accessible, and actionable manner. The user interface elements should be designed to accommodate different types of predicted outputs effectively while promoting user understanding and engagement.

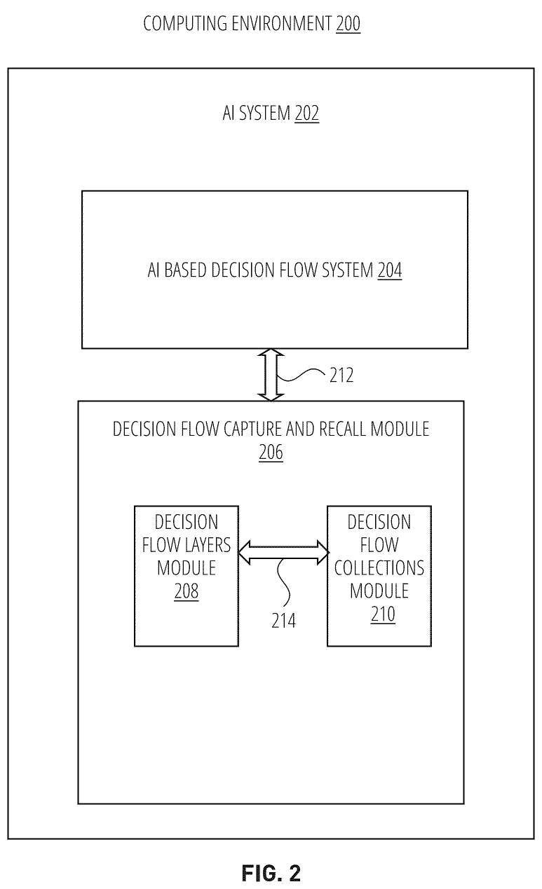

Referring to FIG. 2, an embodiment of a computing environment 200 is shown to comprise an AI system 202, an AI based decision flow system 204, a decision flow capture and recall module 206, a decision flow layers module 208, and a decision flow collections module 210.

The AI based decision flow system 204 includes machine learning model training modules 142, machine learning operation module 144, AI operation module 146 and the NLP module 148 as previously described with respect to FIG. 1.

The AI based decision flow system 204 uses artificial intelligence techniques to make AI decision flows based on a or more predefined sets of rules or decision flows. In an aspect, AI decision flows are a series of steps or actions that the system 202 takes to reach a decision. These flows can be represented as decision trees, flowcharts, or other graphical representations. In the AI based decision flow system 204, the decision flows may guide the system 202 to make the most appropriate decision based on the available data and information. The AI based decision flow system 204 uses machine learning algorithms to learn from past experiences and improve its decision-making capabilities over time. This allows the AI based decision flow system 204 to make more accurate and informed decisions, leading to better outcomes for the user.

In an aspect, the AI based decision flows made by the AI based decision flow system 204 may be workflow processes that are started and then completed after a series of steps and/or execution of code or other logic. One of ordinary skill in the art will appreciate that decision flows may include a sequence, branch, loop, or other logic methods to achieve an outcome after completion of the decision flow steps.

A sequence may include a series of steps that are executed in a specific order. In an AI decision flow, a sequence may include gathering data, processing the data, making a decision based on the processed data, and then taking an action based on that decision.

A branch may include a point in the decision flow where the flow can take one of several different paths based on some condition and may result in child branches in the decision flow. For example, an AI decision flow may use a branch to decide whether to approve or deny a loan application based on the applicant's credit score and then follow the next steps in the process to make further decisions to take an appropriate action or outcome.

A loop may include a series of steps that are repeated until some condition is met. In an AI decision flow, a loop may be used to repeatedly gather data and make decisions until a certain goal is achieved.

Other logic methods may include rules-based systems, decision trees, and neural networks. These methods use different approaches to represent and process information in order to make decisions.

Overall, AI based decision flows may use a combination of these logic methods to achieve an outcome after completion of the decision flow steps.

The quantity of decisions made at any given moment in AI based decision flow system 204 may be influenced by the design of the AI based decision flow system 204 and the data being analyzed. Each internal or conditional point in the decision flow may represent a decision based on a specific attribute of the data. This decision guides which path for the flow to follow through the AI based decision flow system 204. This process may continue until an end or outcome point is reached, symbolizing the final decision or prediction. One of ordinary skill in the art will appreciate that the number of decisions can be quite substantial.

Throughout the processing of a decision flows in the AI based decision flow system 204, for example in cases where decision flows are long running, the decision flows may take several minutes, hours, days, or months to complete. Complex decision flows often include information from multiple inputs and parties before the decision can be made and the decision flows completed to produce or predict outcomes. Some of the decision flows may be paused and placed in a pause or wait state for an indeterminable amount of time until a step, feedback or a missing value of a feature used to make a decision is present. Once the missing information for a decision flow is present, that decision flow needs to be resumed. Interrupted or paused decision flows should be resumed in an efficient manner to facilitate the speed of the decision flow process to predict outcomes.

In FIG. 2, the decision flow capture and recall module 152 of FIG. 1 is depicted as 206. As shown in FIG. 2 a communication bus 212 links the decision flow capture and recall module 206 with the AI based decision flow system 204. The AI based decision flow system 204 is depicted to include a decision flow layers module 208 and a decision flow collections module 210 which communicate with each other via communication bus 214.

The decision flow capture and recall module 206 captures information associated with decision flows in the AI based decision flow system 204 and remembers this information when decision flows in the AI based decision flow system 204 are paused. The decision flow capture and recall module 206 addresses inefficiencies in the resumption of paused decision flows by remembering and recalling context of decision flows.

In one embodiment, context of the decision flows remembered and recalled may include information of prior or preceding decision flow steps, transactions, interactions, and data values captured from the start of a decision flow to a point in time through the decision flow until the decision flow is paused. The context captured may further include prior decision-making execution steps, prior transactions, prior interactions from single or multi-parties, and prior data that have been used as input to produce corresponding output during the prior decision flows.

In one embodiment, remembering the context information is done by memorization. The captured and memorized of context information may be stored in a format that can be easily accessed and recalled to support the decision-making process.

In one embodiment, memorization of context is based on utilization of decision flow layers and decision flow collections.

In one embodiment, remembering values, entities, datapoints and contextual metadata can be processed by an AI system and recorded as a set of original value and/or mathematical representations for recall and can also be used as data for further continuous learning by the AI decision flow system.

In FIG. 2 a decision flow layers module 208 is depicted. In an embodiment, the decision flow layers module 208 creates an abstraction of decision flow steps into logical layers that are grouped and marked. The logical layers represent an abstraction of each decision made in the decision flow steps from a request to its outcome in a more general and simplified manner through the grouping and marking of the decision flow steps, which steps may include sequential steps, and also variations such as, for example, parallel decision steps, branched decision steps and other decision flow steps as described herein before. Further, there may be a decision point to create two or more child decision flows with each sub-decision flow having separate logical layers/decision points. Also, logical layers may not be fixed points within the decision flow and may be logical points from where a decision flow may be restarted.

The logical points may be present at the input of conditional node points (AI/ML models) or somewhere within the nodes (AI/ML models) where more information is required to advance the decision flow. Further, each node (AI/ML model) may communicate with the decision flow layers module 208 allowing it to perform the abstraction. Logical points may be predetermined based on AI learning of policies, Standard Operating Procedures, and real-time user feedback. Logical points can also be forced by organizational requirements such as, for example, forcing a logical layer and decision point around security or risk.

Examples of these logical points may occur at input data processing points where data is parsed, cleaned and encoded for further analysis, at feature extraction points where relevant features have been extracted from the data; at decision nodes within the decision flow where different paths or branches emerge based on specific conditions or criteria for the AI system has evaluated different options or scenarios to determine the appropriate action; parallel processing points where parallel branches may exist within the decision flow from which multiple paths may be executed concurrently; and, points associated with specific stages or significant events in the decision flow.

In the present disclosure these logical points may be marked which allows the logical point in a decision flow to be restarted after a pause or stoppage in the decision flow. Logical layers and their respective marked logical points may not always be at the last step that was concluded in a decision flow and may include a “rewound” logical point prior to the last step in the decision flow better suited for later resumption of the decision flow process.

One of ordinary skill in the art will appreciate that the decision flow may have multiple branches and parallel branches with each branch having continuation through to a stopping point or pause. Therefore, abstraction of captured context of the decision flows by the decision flow layers module 208 may provide a plurality of logical layers and marked logical points within the decision flow.

In FIG. 2 the decision flow capture and recall module 206 includes a decision flow collections module 210. In one embodiment, the decision flow collections module 210 may be used for identifying all related information associated with decision flows including context from the decision flow layers module 208, decision flow steps, decision flow markers, decision flow interactions, decision flow data, and other decision flow objects. It should be understood that the collection of information associated with decision flows may be extended and not restricted within implementations so that the information collected during the decision-making process may be expanded and is not limited to a specific set of data. This allows for more flexibility in the decision-making process and allows for the incorporation of additional information as may be needed. The decision flow collections module 210 may include collections of comprehensive descriptive objectives that capture the related information as the decision flow is initiated and is continuously updated as the decision flow executes. In an embodiment, the collections are each a referenceable and persistent object for easy accessing and remain available after completion of decision flows whereby associated details with any and all decision flows may be remembered and subsequently recalled by the decision flow capture and recall module 206. In an embodiment, the decision flow collection may be in the form of a knowledge graph generated to capture information related to the decision flow. In an aspect, the decision flow capture and recall module 206 includes AI that generates an on-demand knowledge graph and remembers this context and content in relation to the decisions that were made. The on-demand knowledge graph provides a structured representation of information that captures relationships between different entities in a way that is easily understandable by both humans and machines. The on-demand knowledge graph may be used to organize and integrate data from various sources in the decision flow, enabling more effective data analysis and decision-making. The knowledge graph facilitates capture and recalling of context and content related to the decision flows. For example, entities (such as people, places, or things) may be represented as nodes, while relationships between them are represented as edges in the knowledge graph. For example, in a knowledge graph about movies, nodes could represent actors, directors, and films, with edges showing relationships like “acted in” or “directed by.” The knowledge graph may use ontologies to define the types of entities and relationships, providing a semantic layer that helps AI systems understand the context and meaning of the data. The knowledge graph may integrate data from multiple sources, including structured databases, unstructured text, and even real-time data streams, creating a comprehensive view of the information. The knowledge graphs may support complex queries and reasoning, allowing AI systems to infer new information from existing data. For example, if a knowledge graph knows that “Alice is Bob's mother” and “Bob is Charlie's father,” it can infer that “Alice is Charlie's grandmother.” The on-demand knowledge graph may generate and update on-demand captured decision flows ensuring that the most current and relevant information is available for recall of decision-making processes.

It is further envisaged that the decision flow capture and recall module 206 may apply a vector database in addition to the knowledge graph for representation, decision making and memorization. The vector database may be utilized to enhance the decision flow capture and recall module 206 by efficiently managing and querying high-dimensional vector data. This is particularly beneficial for AI-based decision flows, where data points may be represented as vectors capturing various features of the data. The vector database may allow the AI system to perform similarity searches, quickly finding data points similar to a given query vector, which is helpful for real-time applications. By integrating vector databases, the system may manage unstructured data such as text, images, and audio, thereby improving the accuracy and efficiency of decision-making processes. This integration supports the continuous learning and adaptation of the AI system by providing a robust mechanism for storing and retrieving complex data types.

When a decision flow is to be resumed, the decision flow capture and recall module 206 communicates with the AI based decision flow system 204 via communication interface bus 212, the logical point in the decision flow from which the decision flow is to be resumed.

In another embodiment, the decision flow collections module 210 may include a decision flow collection of a memorization technique used to capture and store related information associated with decision flows. This technique may include, for example, one or more of assigning priorities to decision pathways based on adjustable connection weights between artificial neurons; hierarchical tree structures representing decision points and different outcomes to navigate decision flows; memorizing predefined rules to guide decision-making based on learned patterns; reinforcement learning by storing past experiences of actions and outcomes to improve decision-making through trial and error; and, recurrent neural networks (RNNs) that capture temporal dependencies in sequential data for interpreting decision flows that unfold over time.

In an embodiment, the AI system 202 may be trained to learn from the transactional relationships discovered through continuously executing decision flows. This training may involve the AI system 202 gaining knowledge and improving its decision-making abilities by analyzing the patterns and outcomes of its previous transactions that may include interactions or exchanges of data, actions, or events between the AI system 202 and its environment and may include user inputs, system outputs, feedback, or any relevant data points associated with decision-making. This iterative learning process allows the AI system 202 to recognize and understand complex patterns, correlations, and dependencies, enhancing its ability to make more accurate and informed decisions over time.

The ability of the AI system 202 to break decision flows down into decision flow layers, to mark logical points within the decision flows layers, and to record decision flow information in collections allows the AI system 202 to rapidly recall details from memory. This has the advantage of improving accuracy, speed and efficiency of the AI based decision flow system's performance through the reuse of previous knowledge thereby avoiding redundant computations. Memory recall may be accomplished by logically rewinding to a marked logical point in a decision flow layer, then referring to related information captured in the decision flow collection (i.e., context). Memory recall functions may be provided by a descriptive relationship between the marked logical point in the decision flow and the related information that is recalled (i.e., context).

In an aspect, the AI based decision flow system 204 may include a method for creating relationships between 1) decision flows; 2) decision flow layers; 3) decision flow marked logical points; and 4) decision flow information “object relationships” within a collection. In accordance with the present disclosure, the term “object relationships” encompasses a plurality of methods within an implementation, as well as a plurality of diverse information, data, and metadata. The term is intended to be broadly construed and is not limited to any particular type or form of relationship between objects.”

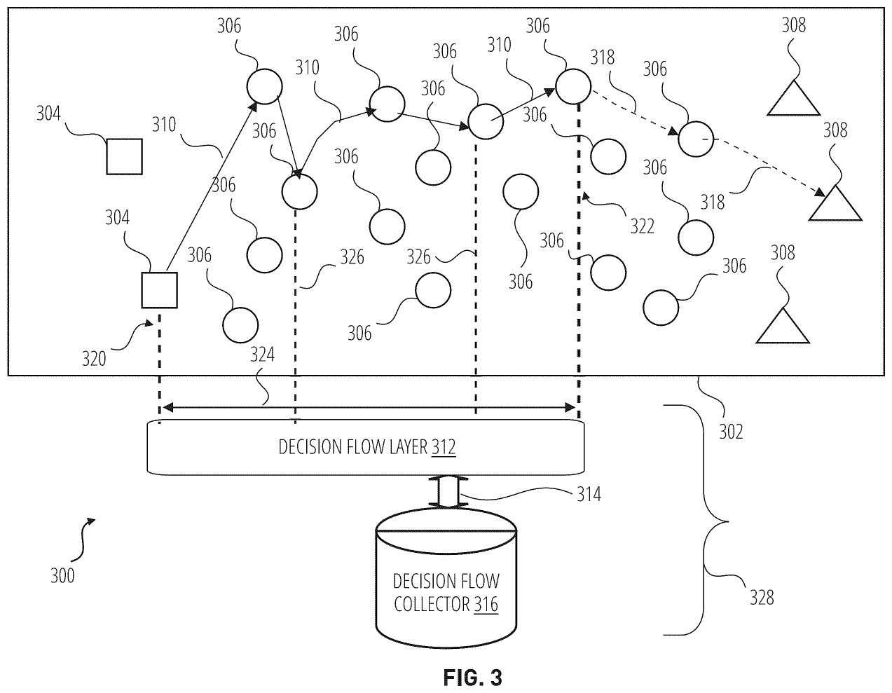

Referring to FIG. 3 there is shown a computing system 300 for remembering and recalling context 324 of paused decision flows 310 to improve efficiency and speed in resuming the paused decision flows in an AI based decisions flow system 302 that, in response to a user (128 of FIG. 1) making a request through a user interface (102 of FIG. 1) performs decision flows 310 by processing a series of decision-making execution steps of code or logic to predict outcomes and make the predicted outcomes available to the user via the user interface.

In FIG. 3 a simplified exemplary decision flow through an AI based decisions flow system 302 is shown. The AI based decisions flow system 302 is shown to include root nodes 304, conditional nodes 306, outcome nodes 308, decision flows 310, a decision flow layer 312, a decision flow collector bus 314, a decision flow collector 316, resumed decision flows 318, a starting request flow point 320, a logical point 322 (which is also the point where the decision flows 310 are shown paused), previous logical points 326 (from which the paused decision flow could be rewound for resumption), and context 324 in the decision flows 310 captured from the starting request flow point 320 up until the pause at logical point 322.

In the AI based decisions flow system 302, the root nodes 304 serve as the starting points or entry points of the AI based decisions flow system 302. The root nodes 304 represent the initial set of conditions or inputs provided to the system 302. These conditions can be in the form of data, variables, or user-defined parameters. The root nodes 304 initiate the decision-making process and branch out into conditional nodes 306. The conditional nodes 306 are the intermediate components of the AI based decisions flow system 302. The conditional nodes 306 evaluate and assess the input data or conditions provided by the root nodes. These conditional nodes 306 contain logical rules, machine learning algorithms, or other decision-making techniques to assess the conditions as discussed herein before. The conditional nodes 306 examine the inputs and make decisions based on predefined rules or algorithms. The conditional nodes 306 may utilize various techniques such as, for example, rule-based systems, decision trees, or neural networks as discussed herein before to determine the appropriate course of action. The outcome nodes 308 are the final components of the AI based decisions flow system 302. The outcome nodes 308 represent the result or outcome of the decision-making process. Based on the evaluations made by the conditional nodes 306, an outcome node 308 is reached. This outcome node 308 presents the final decision or action to be taken based on the input conditions provided. The final decision or action may be a specific output, recommendation, or decision that the AI based decisions flow system 302 generates.

In FIG. 3, a simplified decision flow is shown by the route through the AI based decisions flow system 302 by the full line arrows 310 and broken line arrows 318 from the root nodes 304 where the decision-making process is initiated, through conditional nodes 306 that evaluate the input conditions at root note 304 and any previous conditional node 306 in the decision flow 310, 318 through to the one of the outcome nodes 318 representing the final decision or result generated by the AI based decisions flow system 302. The point 322 represents a pause in the decision flow through the AI based decisions flow system 302.

Referring to both FIG. 1 and FIG. 3, the computing system 300 includes one or more processors 120 for processing the series of decision-making execution steps of code or logic as represented by the decision flow of the AI based decisions flow system 302 to predict outcomes. The computing system 300 further includes the memory(s) 122 (including the applications(s), component(s), API(s), data, etc. stored therein) and/or database 126 to implement or perform the machine readable instruction that when executed, cause the computing system 300 to: capture the context 324 of decision flows 310; determine from the context 324 captured one or more logical points 322, 326 in the decision flow 310 from which a pause in the decision flow, as at logical point 322, may be resumed which resumption is represented in FIG. 3 by resumed decision flows 318; store in the computer memory 122 the one or more logical points 322, 326; recall the one or more logical points 322, 326 from the memory when inputs are present that permit the pause of the decision flow to continue; and resume the decision flow from the one or more logical points 322, 326 utilizing the inputs to continue the series of decision-making execution steps to arrive at the predicted outcomes 308 and make the predicted outcomes available to the user through the user interface. While it is envisaged that the point for resumption in FIG. 3 is logical point 322, it should be understood that if the computing system 300 determines that it is more efficient to resume from a previous logical point 326, the decision flow may be rewound to this previous logical point 326 for resumption of the decision flow.

The decision flow layer 312 may be formed in memory 126 and include instructions that, when executed, cause the system to determine the one or more logical points 322, 326 through abstraction of the captured context 324 and store the abstracted context as decision flow logical layers 312 of memory 126. These instructions may also group and mark the logical layers with decision flow markers at one or more logical points 322, 326. The one or more logical points 322, 326 may comprise multiple non-fixed logical points and the logical layers are marked at the multiple non-fixed logical points within each of the decision flows that are suitable for resuming performance of series of decision-making execution steps from one of the multiple non-fixed logical resume points.

The memory may further comprise instructions that, when executed, cause the system to create and store decision flow collections in a decision flow collector portion 316 of memory that identify a collection of information associated with each of the decision flows where the collected information comprises information related to the decision flow layers, the series of decision-making execution steps, decision flow markers, decision flow interactions, decision flow data, and decision flow objects.

In the embodiment of FIG. 3, the decision flow may be paused at a conditional node 306 when input information to complete the next execution is missing. Missing input information may include new information, information that resolves conflict in input information, and feedback information. Hence, a decision flow may be paused by the computing system 300 to wait for input information that may include new input data information allowing the process to continue, or input data that resolves conflicting data points, and/or feedback information in the decision flow process that may manage complex interactions involving multiple parties. During the pause, the computer system 300 determines the logical points from which the decision flow may be recalled accurately for it to continue, marks the logical points, and memorizes the marked logical points with the context of the decision flow. The missing or conflicted input information and/or feedback information that may cause a decision flow to pause may come from various sources and may take different forms. One example of this may be data or information provided by a user to permit the decision flow to proceed. For instance, a user might need to input specific details or make a selection before the next step can be executed. Another example may be that the decision flow is waiting for data from external systems or databases. This could include fetching information from a CRM system, retrieving customer data, or getting updates from other integrated systems. Another example may be that in complex decision flows involving multiple parties, feedback from other stakeholders or team members may be involved. This could include approvals, comments, or additional information that needs to be incorporated into the decision flow. Another example may be that the decision flow is paused until certain prior steps or processes are completed. This ensures that prerequisites are met before moving forward. Yet another example may be that the decision flow is waiting for automated processes or scripts to complete their execution. This could involve running specific algorithms, processing large datasets, or performing other computational tasks. These inputs or feedback allow the decision flow to continue accurately and effectively, ensuring that information is available and that the flow can proceed seamlessly from the marked logical points.

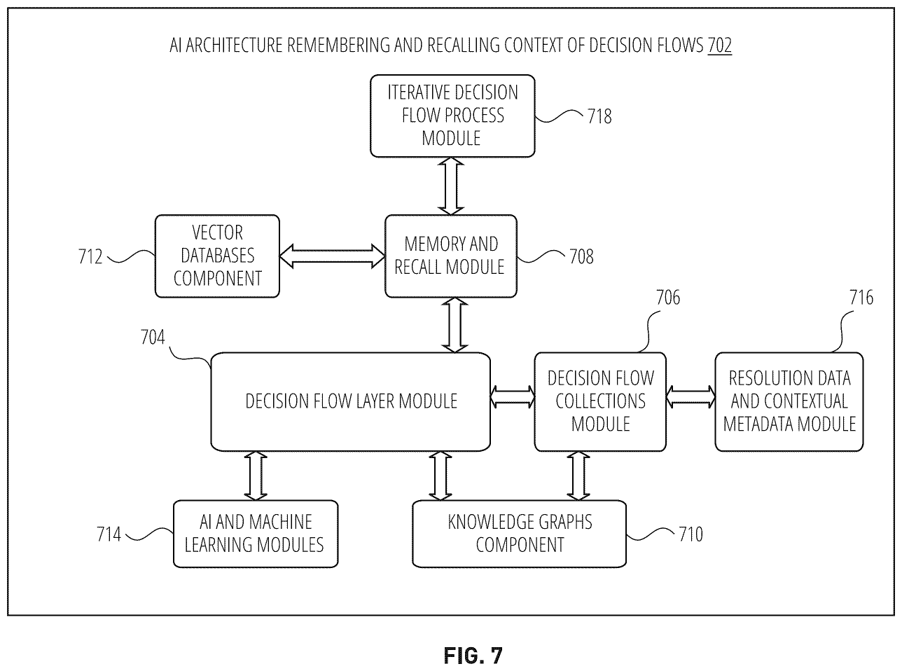

In FIG. 3, the decision flow layer 312, the decision flow collector 316, and the capturing of context 324 form part of a knowledge repository 328 of the architecture of the AI based decision flow system for remembering and recalling the context of the decisions flows. This architecture is described further with reference to FIG. 7.

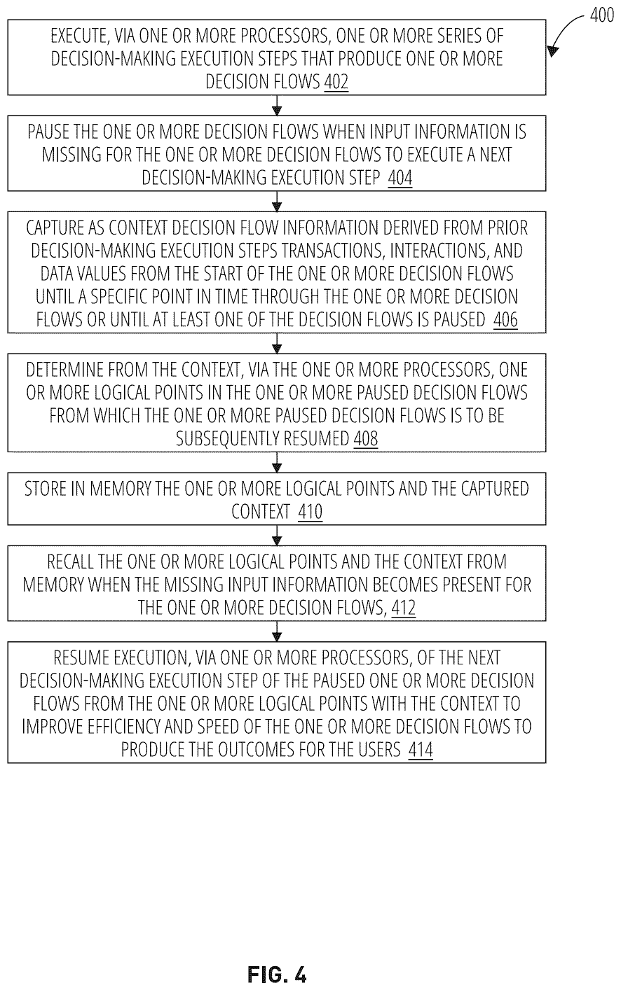

FIG. 4 illustrates a routine 400 for remembering and recalling context of decision flows in an AI based decision flow system that produces outcomes for users in response to user requests in accordance with one embodiment.

In block 402, routine 400 executes, via one or more processors, one or more series of decision-making execution steps that produce one or more decision flows. In block 404, routine 400 pauses the one or more decision flows when input information is missing for the one or more decision flows to execute a next decision-making execution step. In block 406, routine 400 captures as context decision flow information derived from prior decision-making execution steps transactions, interactions, and data values from the start of the one or more decision flows until a specific point in time through the one or more decision flows or until at least one of the decision flows is paused. In block 408, routine 400 determines from the context, via the one or more processors, one or more logical points in the one or more paused decision flows from which the one or more paused decision flows is to be subsequently resumed. In block 410, routine 400 stores in memory the one or more logical points and the captured context. In block 412, routine 400 recalls the one or more logical points and the context from memory when the missing input information becomes present for the one or more decision flows. In block 414, routine 400 resumes execution, via one or more processors of the next decision-making execution step of the paused one or more decision flows from the one or more logical points with the context to improve efficiency and speed of the one or more decision flows to produce the outcomes for the users.

Routine 400 ensures that the AI-based decision flow system can efficiently pause and resume decision flows, thereby improving the overall speed and effectiveness of producing outcomes for users.

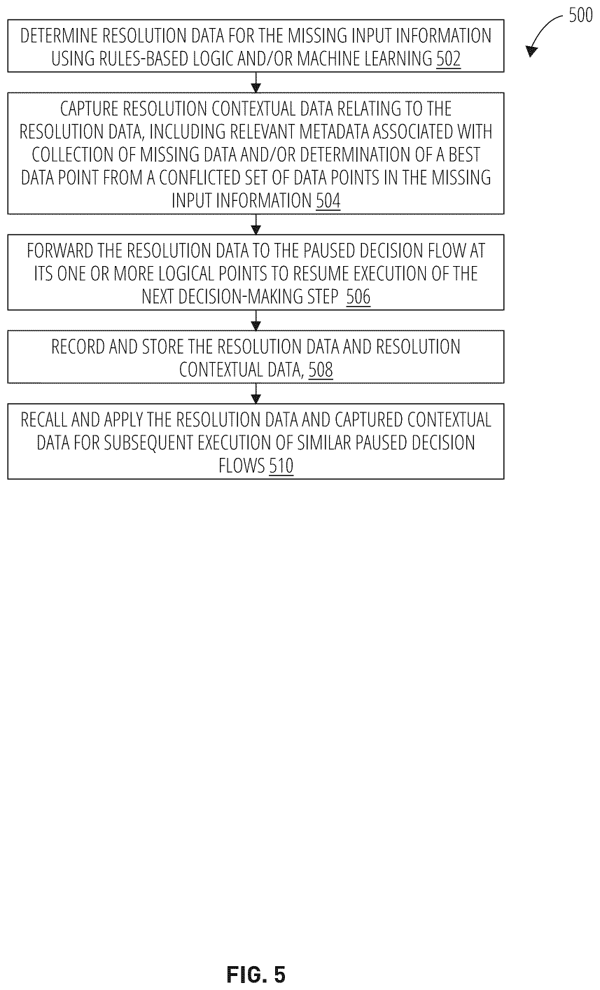

FIG. 5 illustrates a routine 500 that is a continuation of the routine 400 in FIG. 4. for remembering and recalling context of decision flows in an AI based decision flow system that produces outcomes for users in response to user requests in accordance with one embodiment.

In block 502, routine 500 determines resolution data for the missing input information using rules-based logic and/or machine learning. In block 504, routine 500 captures resolution contextual data relating to the resolution data, including relevant metadata associated with collection of missing data and/or determination of a best data point from a conflicted set of data points in the missing input information. In block 506, routine 500 forwards the resolution data to the paused decision flow at its one or more logical points to resume execution of the next decision-making step. In block 508, routine 500 records and stores the resolution data and resolution contextual data. In block 510, routine 500 recalls and applies the resolution data and captured contextual data for subsequent execution of similar paused decision flows. In block 602, routine 600 adjusts the one or more decision flows based on prior memory recall of resolution data, contextual data, and context decision flow information to allow the AI based decision flow system to continuously learn and adapt through iterations.

Thus FIG. 5 illustrates a further embodiment of the routine by addressing the handling of missing input information, which may include missing data, conflicting data, and feedback data. The routine 500 records and stores the resolution data and resolution contextual data and recalls and applies this data for subsequent execution of similar paused decision flows. This ensures that the AI-based decision flow system can efficiently manage missing or conflicting data, thereby improving the overall speed and effectiveness of producing outcomes for users.

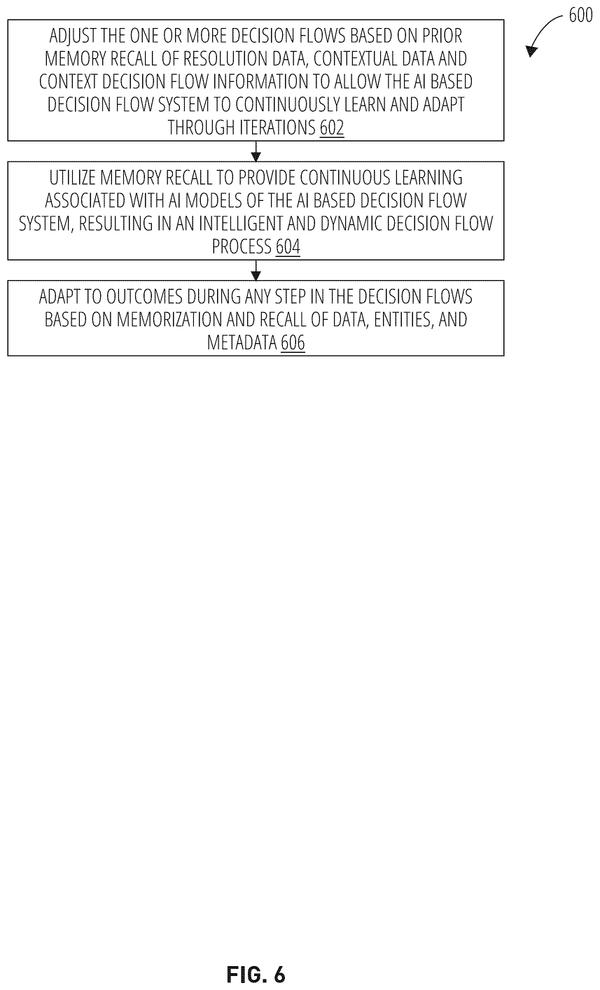

FIG. 6 illustrates a routine 600 that is a continuation of the routine 500 in FIG. 5. for remembering and recalling context of decision flows in an AI based decision flow system that produces outcomes for users in response to user requests in accordance with one embodiment.

In block 604, routine 600 utilizes memory recall to provide continuous learning associated with AI models of the AI based decision flow system, resulting in an intelligent and dynamic decision flow process. In block 606, routine 600 adapts to outcomes during any step in the decision flows based on memorization and recall of data, entities, and metadata.

Thus FIG. 6 illustrates that the routine introduces a further embodiment by introducing iterative decision flows that provide dynamic learning. The routine 600 adjusts the decision flows based on prior memory recall of resolution data, contextual data, and context decision flow information. This allows the AI-based decision flow system to continuously learn and adapt through iterations. The routine 600 utilizes memory recall to provide continuous learning associated with AI models, resulting in an intelligent and dynamic decision flow process. It adapts to outcomes during any step in the decision flows based on memorization and recall of data, entities, and metadata. This iterative approach ensures that the AI-based decision flow system remains flexible and responsive to changing conditions, further enhancing its efficiency and effectiveness.

It should be understood that the routines 400, 500, and 600 may be embodied in a non-transitory computer-readable storage medium wherein the computer-readable storage medium includes instructions that when executed by a computer, operating in an AI based decision flow system, cause the computer to execute all or portions of these routines.

FIG. 7 illustrates an exemplary architecture 702 for remembering and recalling context of decision flows in an AI based decision flow system. This architecture 702 may comprise the decision flow capture and recall module/architecture 152, 206 previously described in FIG. 1 and FIG. 2, respectively. The architecture 702 may further include machine learning model training modules 142, machine learning operation module 144, AI operation module 146 and the NLP module 148 as previously described with respect to FIG. 1. The architecture 702 comprises a knowledge repository that stores and organizes information, data, and knowledge. It serves as a resource for AI based systems to access and retrieve relevant information to perform tasks, answer questions, and make decisions. The architecture 700 may have several interconnected modules and components, that may be implemented in various computing environments, including closed computing systems, cloud-based computing networks, or a hybrid of closed and cloud-based environments. The exemplary interconnected modules and components may each play a role in enhancing the efficiency, accuracy, and adaptability of remembering and recalling context of decision flows in the AI based decision flow system.

At the core of the architecture is the Decision Flow Layers Module 704, which creates an abstraction of decision flow steps into logical layers. These logical layers represent an abstraction of each decision made in the decision flow steps from a request to its outcome. The logical points within these logical layers are marked, allowing the decision flow to be resumed efficiently from these marked logical points.

Adjacent to the Decision Flow Layers Module 704 is the Decision Flow Collections Module 706. This module identifies and collects information associated with decision flows, including context from the decision flow layers, decision flow steps, decision flow markers, interactions, data, and other objects. This comprehensive collection of information is stored in a persistent and referenceable format, ensuring that all relevant data is available for future decision flows.

Above the Decision Flow Layers Module 704 is a Memory and Recall Module 708. This module captures context from decision flows, including prior decision-making steps, transactions, interactions, and data values. The context is stored or recorded in memory and recalled when the decision flow needs to be resumed. The system uses memory recall to provide continuous learning and adapt to outcomes during any step in the decision flow.

Connected to both the Decision Flow Layers Module 704 and the Decision Flow Collections Module 706 is Knowledge Graphs component 710. Knowledge graphs organize and integrate data from various sources, enabling effective data analysis and decision-making. They provide a structured representation of information that captures relationships between different entities in a way that is easily understandable by both humans and machines.

Connected to the Memory and Recall Module 708 is a Vector Databases component 712. This component manages and queries high-dimensional vector data, improving the accuracy and efficiency of decision-making processes. Vector databases are particularly beneficial for AI-based decision flows, where data points may be represented as vectors capturing various features of the data.

At the bottom of the schematic, connected to the Decision Flow Layers Module 704, are the AI and Machine Learning Modules 714. These modules train and operate models to support decision-making. They use various techniques, such as, for example, neural networks, reinforcement learning, natural language processing and others previously described, to enhance the decision flow process.

Next to the Decision Flow Collections Module 706 is a Resolution Data and Contextual Metadata Module 716. This module resolves missing or conflicted data points using rules-based logic or machine learning. The resolution process involves capturing contextual data and storing it for future reference, enabling the system to automatically resolve similar issues in subsequent decision flows.

At the top of the schematic, connected to the Memory and Recall Module 708, is the Iterative Decision Flow Process Module 718. This module allows the decision flow process to be iterative, enabling continuous learning and adaptation.

The dynamic learning process helps improve the accuracy and efficiency of decision-making by allowing the AI system to learn from prior memory recall and adapt to new outcomes.

In summary, FIG. 7 is an exemplary depiction of an architecture 702 that integrates various modules and components to form a comprehensive remembering and recalling of context decision flow layer within an AI based decision flow system. The interconnected modules work together to enhance the system's ability to pause and resume decision flows effectively while continuously improving through learning from past remembered experiences.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical.

What is claimed is:

1. A computer implemented method for remembering and recalling context of decision flows in an AI based decision flow system that produces outcomes for users in response to user requests, the method comprising:
executing, via one or more processors, one or more series of decision-making execution steps that produce one or more decision flows;
pausing the one or more decision flows when input information is missing for the one or more decision flows to execute a next decision-making execution step;
capturing as the context decision flow information derived from prior decision-making execution steps transactions, interactions, and data values from start of the one or more decision flows until a specific point in time through the one or more decision flows or until at least one of the decision flows is paused;
determining from the context, via the one or more processors, one or more logical points in the one or more paused decision flows from which the one or more paused decision flows is to be subsequently resumed;
storing in memory the one or more logical points and the captured context;
recalling the one or more logical points and the context from memory when the missing input information becomes present for the one or more decision flows; and,
resuming execution, via the one or more processors, of the next decision-making execution step for the paused decision flows from the one or more logical points with the context to improve efficiency and speed of the one or more decision flows to produce the outcomes the users.

2. The computer implemented method of claim 1 wherein the step of determining from the context the one or more logical points is by abstraction of the context into decision flow logical layers, and grouping and marking the decision flow logical layers with decision flow markers at the one or more logical points and wherein the step recalling comprises rewinding to the decision flow markers in the decision flow logical layers.

3. The computer implemented method of claim 2 wherein the one or more logical points comprise multiple non-fixed logical points and the decision flow logical layers are marked at the multiple non-fixed logical points within each of the decision flows that are suitable for resuming performance of series of decision-making execution steps from one of the multiple non-fixed logical resume points.

4. The computer implemented method of claim 2, wherein the step of storing in memory further comprises creating and storing decision flow collections that identify and collect information associated with each of the decision flows comprising information related to the decision flow logical layers, series of decision-making execution steps, the decision flow markers, decision flow interactions, decision flow data, and decision flow objects.

5. The computer implemented method of claim 2, wherein the one or more logical points comprise last points captured, and points prior to the last points captured, in the paused decision flow.

6. The computer implemented method of claim 1, wherein the missing input information comprises missing data, conflicting data and feedback data, and the method further comprises:
determining resolution data for the missing input information using rules-based logic and/or machine learning;
capturing resolution contextual data relating to the resolution data, including relevant metadata associated with collection of missing data and/or determination of a best data point from a conflicted set of data points in the missing forwarding the resolution data to the paused decision flow at the one or more logical points to resume execution of the next decision-making step;
recording and storing the resolution data and resolution contextual data; and,
recalling and applying the resolution data and captured contextual data for subsequent execution of similar paused decision flows.

7. The computer implemented method of claim 6, wherein the one or more decision flows the AI based decision flow system are iterative decision flows providing dynamic learning, and the method further comprises:
adjusting the one or more decision flows based on prior memory recall of resolution data, the contextual data, and context decision flow information to allow the AI based decision flow system to continuously learn and adapt through iterations;
utilizing memory recall to provide continuous learning associated with AI models of the AI based decision flow system, resulting in an intelligent and dynamic decision flow process; and
adapting to outcomes during any step in the decision flows based on memorization and recall of data, entities, and metadata.

8. A computing system for remembering and recalling context of paused decision flows to improve efficiency and speed in resuming the paused decision flows in an AI based decision flow system that, in response to a user making a request through a user interface, performs decision flows by processing a series of decision-making execution steps of code or logic to predict outcomes and make the predicted outcomes available to the user via the user interface, the system comprising:
one or more processors; and
a memory comprising instructions that when executed, cause the computing system to:
capture the context of one or more decision flows comprising decision flow information derived from prior decision-making execution steps transactions, interactions, and data values from start of the one or more decision flows until a specific point in time through the one or more decision flows or until at least one of the decision flows is paused;
determine from the context one or more logical points at which one or more of the paused decision flows have occurred and from where the one or more of the paused decision flows may be resumed;
store in the memory the one or more logical points and the context captured;
recall the one or more logical points from the memory when inputs are present that permit the paused decision flow to continue; and
resume the one or more of the paused decision flows from the one or more logical points utilizing the inputs to continue the series of decision-making execution steps to arrive at the predicted outcomes and make the predicted outcomes available to the user through the user interface.

9. The computing system of claim 8, the memory comprising further instructions that, when executed, cause the system to capture for the context of the paused decision flow, one or more of prior decision-making execution steps, prior transactions, prior interactions from single or multi-parties, and prior data that has been used as input to produce corresponding output during the prior decision flows.

10. The computing system of claim 9, the memory comprising further instructions that, when executed, cause the system to determine the one or more logical points via abstraction of the context captured into decision flow logical layers, and grouping and marking in decision flow logical layers the logical points with decision flow markers at the one or more logical points; and wherein the memory comprising further instructions that, when executed, cause the system to recall the one or more logical points from the decision flow markers in the decision flow logical layers.

11. The computing system of claim 10, wherein the one or more logical points comprise multiple non-fixed logical points and the logical layers are marked at the multiple non-fixed logical points within each of the decision flows that are suitable for resuming performance of series of decision-making execution steps from one of the multiple non-fixed logical resume points.

12. The computing system of claim 9, the memory comprising further instructions that, when executed, cause the system to create and store decision flow collections that identify a collection of information associated each of the decision flows where the collected information comprises information related to the logical layers, series of decision-making execution steps, decision flow markers, decision flow interactions, decision flow data, and decision flow objects.

13. The computing system of claim 8, wherein the one or more logical points comprise last points captured, and points prior to the last points captured, in the paused decision flow.

14. The computing system of claim 8, wherein the missing input information comprises missing data, conflicting data and feedback data, and the memory further comprising instructions that when executed, cause the computing system to:
determine resolution data for the missing input information using rules-based logic and/or machine learning;
capture resolution contextual data relating to the resolution data, including relevant metadata associated with collection of missing data and/or determination of a best data point from a conflicted set of data points in the missing forward the resolution data to the paused decision flow at its one or more logical points to resume execution of the next decision-making step;
record and store the resolution data and resolution contextual data; and,
recall and apply the resolution data and captured contextual data for subsequent execution of similar paused decision flows.

15. The computer system of claim 14, wherein the one or more decision flows of the AI based decision flow system are iterative decision flows providing dynamic learning, and the memory further comprising instructions that when executed, cause the computing system to:
adjust the one or more decision flows based on prior memory recall of resolution data, contextual data, and context decision flow information to allow the AI based decision flow system to continuously learn and adapt through iterations;
utilize memory recall to provide continuous learning associated with AI models of the AI based decision flow system, resulting in an intelligent and dynamic decision flow process; and
adapt to outcomes during any step in the decision flows based on memorization and recall of data, entities, and metadata.

16. A non-transitory computer-readable storage medium, the computer-readable storage medium comprising executable instructions that, when executed by a computer operating in an AI based decision flow system, cause the computer to:
capture context of one or more decision flows;
determine from the context captured one or more logical points at which one or more of the paused decision flows have occurred and from where the one or more of the paused decision flows may be resumed;
store in the memory the one or more logical points and the context captured;
recall the one or more logical points from the memory when inputs are present that permit the one or more paused decision flows to continue; and
resume the one or more of the paused decision flows from the one or more logical points utilizing the inputs to continue decision-making execution steps of the one or more decision flows to arrive at predicted outcomes and make the predicted outcomes available to the user through a user interface.

17. The non-transitory computer-readable storage medium of claim 16, comprising further executable instructions that, when executed by a computer, cause the computer to:
determine the one or more logical points, by abstraction of the context captured into decision flow logical layers, and grouping and marking the decision flow logical layers with decision flow markers at the one or more logical points;
recall the one or more logical points from the decision flow markers in the decision flow logical layers;
wherein the one or more logical points comprise last points captured, and points prior to the last points captured, in the paused decision flow; and,
wherein the one or more logical points comprise multiple non-fixed logical points and the decision flow logical layers are marked at the multiple non-fixed logical points within each of the decision flows that are suitable for resuming performance of series of decision-making execution steps from one of the multiple non-fixed logical resume points.

18. The non-transitory computer-readable storage medium of claim 15, comprising further executable instructions that, when executed by a computer, cause the computer to:
create and store decision flow collections that identify and collect information associated with each of the decision flows and the collected information comprising information related to the decision flow logical layers, series of decision-making execution steps, decision flow markers, decision flow interactions, decision flow data, and decision flow objects.

19. The non-transitory computer-readable storage medium of claim 17, wherein the missing input information comprises missing data, conflicting data and feedback data, and comprising further executable instructions that, when executed by a computer, cause the computer to:
determine resolution data for the missing input information using rules-based logic and/or machine learning;
capture resolution contextual data relating to the resolution data, including relevant metadata associated with collection of missing data and/or determination of a best data point from a conflicted set of data points in the missing input information;
forward the resolution data to the paused decision flow at its one or more logical points to resume execution of the next decision-making step;
record and store the resolution data and resolution contextual data; and,
recall and apply the resolution data and captured contextual data for subsequent execution of similar paused decision flows.

20. The non-transitory computer-readable storage medium of claim 19,
wherein the one or more decision flows in the AI based decision flow system are iterative decision flows providing dynamic learning, and comprising further executable instructions that, when executed by a computer, cause the computer to:
adjust the one or more decision flows based on prior memory recall of resolution data, contextual data, and context decision flow information to allow the AI based decision flow system to continuously learn and adapt through iterations;
utilize memory recall to provide continuous learning associated with AI models of the AI based decision flow system, resulting in an intelligent and dynamic decision flow process; and
adapt to outcomes during any step in the decision flows based on memorization and recall of data, entities, and metadata.
